(19) United States
(12) Patent Application Publication
(10) Pub. No.: US 2006/0072438 A1
(43) Pub. Date: Apr. 6, 2006

(54) Optical information recording substrate and recording/reproducing device using it

(76) Inventors: Seiji Nishino, Osaka-shi (JP); Teruhiro Shiono, Osaka-shi (JP); Hiroaki Yamamoto, Kawabe-gun (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 10/527,018

(22) PCT Filed: Sep. 2, 2003
(86) PCT No.: PCT/JP03/11220

§ 371 Date: Mar. 8, 2005

(30) Foreign Application Priority Data
Sep. 30, 2002 (JP) 2002-286745

(51) Int. Cl. G11B 7/24

(52) U.S. Cl. 369/275.1; 369/283; 369/272.1

(57) ABSTRACT

To provide an optical information storage medium with high recording/reproducing sensitivity.

An optical information storage medium 100 includes a substrate 56 and a multilayer structure 49, which is provided on the substrate 56 and includes at least one storage layer 57. The storage layer 57 includes polydiacetylene or merocyanine and is amorphous.

### TECHNICAL FIELD

The present invention relates to an optical information storage medium and also relates to a method and apparatus for reading and/or writing information from/on an optical information storage medium.

### BACKGROUND ART

As it has become more and more necessary to store a huge amount of information recently, there is a growing demand for optical information storage media (which are also called “optical disks”) with increased densities.

The storage density of an optical disk is proportional to the wavelength λ of a read/write beam and the numerical aperture NA of an objective lens. Lately, it was discovered that the storage density of an optical disk with a diameter of 5 inches could be increased to 25 GB by using a GaN laser diode that emits a laser beam with a wavelength λ of 405 nm and an objective lens with an NA of 0.85 in combination. This storage density is about six times as high as that of a conventional DVD.

However, the conventional approach of increasing the storage density of an optical disk by using an objective lens with the largest possible numerical aperture NA and a read/write beam with the shortest possible wavelength λ has almost reached a deadlock. Specifically, if the wavelength of the light emitted from a light source were shorter than 405 nm, the optical transmittance of a disk carrier resin substrate (i.e., a polycarbonate substrate), which is usually used in an optical disk, would decrease sharply. And if the light had a wavelength shorter than 400 nm, not just the decrease in the transmittance of the resin substrate but also the decomposition of the disk carrier resin substrate due to a long exposure to such a short wave radiation should be brought about. As a result, the optical transmittance would further decrease, which is a serious problem.

Meanwhile, the larger the NA of an objective lens, the shorter the working distance WD of the objective lens. And as the WD decreases, the objective lens is more likely to collide against the disk. In addition, if the WD is short, a protective layer with a sufficient thickness cannot be provided on the storage layer. For example, if the NA were set greater than the value mentioned above (i.e., 0.85), then the WD would decrease so much that the protective layer could have a thickness of 100 μm or less considering the tilt margin of the disk. With such a thin protective layer, the dirt deposited on the disk surface (i.e., the surface of the protective layer) would be so much close to the storage layer, of which the surface should produce read signals, that even a small dirt on the disk surface might deteriorate the quality of the read signals of the disk significantly.

That is why a deep-rooted problem should arise if the wavelength λ were simply further decreased and if the NA of the objective lens were just increased further. One of key approaches to realize an optical disk with an even higher density while avoiding such a complicated problem is to provide multiple storage layers for a single disk.

FIG. 7 illustrates an exemplary configuration for an optical disk with multiple storage layers. In the configuration shown in FIG. 7, a semi-transparent storage layer 51 is provided on a supporting substrate 56. On the semi-transparent storage layer 51, heat insulating layers 53 and semi-transparent storage layers 51 are alternately stacked. The uppermost semi-transparent storage layer 51 is covered with a protective layer 50. In the optical disk shown in FIG. 7, if a light beam is focused on one of the semi-transparent storage layers 51, on which information is going to be stored, then the light-beam is absorbed into the semi-transparent storage layer 51. Having absorbed the light beam, the semi-transparent storage layer 51 generates heat locally to produce a phase transition or deformation. Thus, by using this phenomenon, a signal can be written on the semi-transparent storage layer 51. Accordingly, if multiple semi-transparent storage layers 51 are stacked one upon the other as shown in FIG. 7, information can be stored in those layers and the storage density can be increased as a result.

However, in such a conventional structure including multiple semi-transparent storage layers 51 stacked, when the light beam is focused on one semi-transparent storage layer 51 on which the information is going to be written, other semi-transparent storage layers 51, located closer to the source of the incoming light, are also exposed to that light and absorb the light, too. As a result, the amount of the light reaching the semi-transparent storage layer 51 on which the information is going to be written decreases. Due to this problem, if the number of semi-transparent storage layers 51 to stack were four, five or more, then the light would attenuate so much as to make it difficult to write information on any deeper semi-transparent storage layer 51. Consequently, the storage capacity would be limited.

To overcome this light attenuation problem, a storage method utilizing a “light-induced refractive index variation” has been researched recently.

For example, Japanese Patent Publication No. 2961126 describes a method of storing information as a spatial refractive index distribution by producing a light-induced refractive index variation, which seems to be caused by the rearrangement of charged particles due to defects, at a very small spot by focusing a pulsed laser beam into a glass matrix. This light-induced refractive index variation utilizes multiphoton absorption produced by irradiating glass with intense light.

Multiphoton absorption is produced when a given substance is irradiated with light with a sufficiently high intensity but is never produced just by exposing the same substance to light with a normal intensity. For that reason, when a layer, which is transparent to the wavelength of a write beam (which will be sometimes referred to herein as a “transparent storage layer”), is used as a storage layer to which the multiphoton absorption is applied, even if the other transparent storage layers, located closer to the light source than the target transparent storage layer, are exposed to the light beam, no multiphoton absorption will be produced there. This is because the light beam is not focused on any of the other storage layers and has a relatively low intensity. Thus, the light beam can pass the other transparent storage layers without attenuating. Meanwhile, in that portion of the target transparent storage layer, on which the light beam is being focused (i.e., the portion near the focal point of the light beam), the intensity of the light beam is high enough to produce the multiphoton absorption, thereby producing the light-induced refractive index variation and forming a spot that has a different refractive index from those of the other areas.

Suppose a storage layer 57 as disclosed by the patent mentioned above is provided between a substrate 56 and a protective layer 50 as shown in FIG. 8, for example. The storage layer 57 is made of a material including silica glass as its main ingredient. In the storage layer 57, the multiphoton absorption and light-induced refractive index variation are produced only in the vicinity of the focal point 3 of the incoming light. Thus, by controlling the focal point 3, information can be stored on multiple layers. As a result, a number of write signal tracks 55 are left.

As used herein, the “multiphoton absorption” refers to a phenomenon that a substance absorbs a plurality of photons (of either the same type or different types), i.e., absorption involving a plurality of transitions. Meanwhile, conventional absorption of light (i.e., absorption involving just a single transition process) will be sometimes referred to herein as “single photon absorption”.

Most of conventional storage layers, utilizing the light-induced refractive index variation, are made of an inorganic material such as silica glass as in the patent mentioned above. The reason is that a lot of inorganic materials can write information with relatively high sensitivity by producing the light-induced refractive index variation. This is also because with an inorganic material, a transparent layer can be obtained relatively easily by making an oxide film, a nitride film, a sulfide film, etc. of the inorganic material. As described above, if the storage layer is basically transparent to the light with the same wavelength as that of a write beam, the light attenuation problem would not arise and information can be written on multiple layers as intended.

The multilayer storage structure shown in FIG. 8 is simple enough to allow for mass production. However, the recording/reproducing sensitivity thereof is low. In the method that utilizes the light-induced refractive index variation as described above, information is written as a plurality of spots with mutually different refractive indices. That is why the resultant recording/reproducing sensitivity should be lower than the method of writing information as physical pits.

In order to overcome the problems described above, a major object of the present invention is to increase the sensitivity with which information is read or written from/on an optical information storage medium by utilizing the multiphoton absorption phenomenon.

### DISCLOSURE OF INVENTION

An optical information storage medium according to the present invention includes a substrate and a multilayer structure, which is provided on the substrate and includes at least one storage layer. The at least one storage layer includes polydiacetylene or merocyanine and is amorphous.

In one preferred embodiment, the multilayer structure further includes a thermoplastic resin layer that is arranged so as to contact with at least one surface of the at least one storage layer.

Another optical information storage medium according to the present invention includes a substrate and a multilayer structure, which is provided on the substrate and includes at least one storage layer. The multilayer structure further includes a thermoplastic resin layer that is arranged so as to contact with at least one surface of the at least one storage layer.

In one preferred embodiment, the at least one storage layer includes at least one compound selected from the group consisting of tellurium oxide, zinc oxide and zinc sulfide and is amorphous.

The optical information storage medium may further include a heat insulating layer for reducing conduction of heat that has been generated in the at least one storage layer. In that case, the thermoplastic resin layer may be arranged so as to contact with one surface of the at least one storage layer, and the heat insulating layer may be arranged so as to contact with the other surface of the at least one storage layer.

The heat insulating layer may include either a thermosetting resin or an inorganic oxide or inorganic sulfide that is different from the material of the at least one storage layer.

The at least one storage layer is preferably substantially transparent to a write beam with a first wavelength and a read beam with a second wavelength, and preferably produces multiphoton absorption against the write beam.

The material of the at least one storage layer preferably has a third-order nonlinear constant of at least 0.5×10⁻¹² esu.

In one preferred embodiment, the second wavelength is approximately half as long as the first wavelength.

In another preferred embodiment, the thickness of the at least one storage layer may be defined so as not to reflect the write beam but to reflect the read beam.

The optical information storage medium may include a plurality of storage layers including the at least one storage layer. In that case, the storage layers may be arranged so as to be spaced apart from each other by a separating layer.

Information is preferably stored in multiple layers within the at least one storage layer.

A method according to the present invention is a method for reading and/or writing information from/on the optical information storage medium described above. The method includes the step(s) of writing the information including the step of producing multiphoton absorption locally in the at least one storage layer of the optical information storage medium by focusing a write beam on the at least one storage layer, and/or reading the information by focusing a read beam on the at least one storage layer of the optical information storage medium and detecting light reflected therefrom.

An apparatus according to the present invention is an apparatus for reading and/or writing information from/on the optical information storage medium. The apparatus performs the step(s) of writing the information including the step of producing multiphoton absorption locally in the at least one storage layer of the optical information storage medium by focusing a write beam on the at least one storage layer, and/or reading the information by focusing a read beam on the at least one storage layer of the optical information storage medium and detecting light reflected therefrom.

In one preferred embodiment, the second wavelength is approximately half as long as the first wavelength.

The write beam preferably has one emission duration of 15 picoseconds to 15 nanoseconds.

### BRIEF DESCRIPTION OF DRAWINGS

FIG. 1 is a cross-sectional view schematically illustrating an optical information storage medium according to a preferred embodiment of the present invention.

FIG. 2 is a cross-sectional view schematically illustrating an optical information storage medium according to another preferred embodiment of the present invention.

FIG. 3 is a cross-sectional view schematically illustrating an optical information storage medium according to still another preferred embodiment of the present invention.

FIG. 4 is a graph showing the spectral characteristic of merocyanine.

FIG. 5 is a graph showing the spectral characteristic of polydiacetylene.

FIG. 6 shows a configuration for a read/write drive according to a preferred embodiment of the present invention.

FIG. 7 is a cross-sectional view illustrating a configuration for a conventional optical information storage medium with a multilayer structure.

FIG. 8 is a cross-sectional view illustrating a configuration for an optical information storage medium that utilizes multiphoton absorption.

### BEST MODE FOR CARRYING OUT THE INVENTION

To increase the sensitivity of an optical read/write operation utilizing the multiphoton absorption, the present inventors researched a storage method in which the light-induced refractive index variation is not used but heat is generated efficiently and thermal deformation is produced through the multiphoton absorption, thereby making physical unevenness (i.e., pits) on the storage layer.

The conventional storage layer, utilizing the light-induced refractive index variation, can produce the multiphoton absorption. But it is difficult to make physical pits in such a storage layer through thermal deformation.

The storage layer 57 shown in FIG. 8 is made of an inorganic glass material (e.g., silica glass) such as an inorganic oxide, an inorganic nitride or an inorganic sulfide. In the storage layer 57 made of such a material, pits are not formed easily through thermal deformation. In other words, the storage layer 57 has low recording sensitivity mainly for the following three reasons:

Firstly, the storage layer 57 made of such a material has so high thermal conductivity that the heat generated at the focal point 3 easily diffuses into portions of the storage layer 57 surrounding the focal point 3. Thus, increase in temperature at the focal point 3 is reduced, and therefore, the storage layer 57 is not thermally deformed easily. Secondly, the inorganic compound (i.e., glass in this case) such as silica glass has a higher thermal deformation temperature, and higher hardness, than a metal compound for use in a storage layer that produces single photon absorption. Accordingly, even if multiphoton absorption has been produced and heat has been generated at the focal point 3 in the storage layer 57, deformation will not be produced easily in the vicinity of the focal point 3. Thirdly, silica glass has a small third-order nonlinear constant (of 0.01×10⁻¹² esu, for example). For that reason, even if the multiphoton absorption has been produced, that material does not generate heat easily (i.e., has low heat generating efficiency).

Specifically, the inorganic compound (glass) and the metal compound may have the following thermal deformation temperatures. As a conventional optical storage material that produces single photon absorption, a Te-metal compound (e.g., 60Te20Ge10Ab) is well known. This metal compound has a melting temperature of about 230° C. On the other hand, a storage material that easily produces multiphoton absorption, e.g., Te oxide compound (such as tellurium oxide including 20 mol % of Na (20Na80TeO₂)), has a melting temperature of about 500° C. Thus, it can be seen that by using such an inorganic compound as a material for the storage layer, thermal melting or deformation is not produced so easily as in the situation where the Te-metal compound is used.

That is why it is difficult to make physical pits in a storage layer made of an inorganic glass material by utilizing multiphoton absorption (which will be referred to herein as “multiphoton absorption storage”). To carry out the multiphoton absorption storage, a light beam with an extremely high intensity needs to be focused on the storage layer. A semiconductor laser diode, which has been frequently used as a light source to emit a write beam toward an optical disk, often has an optical output that is not high enough to make those pits in such a storage layer. A high-output laser diode such as a YAG laser may be used as a write beam source that has a higher optical output than the semiconductor laser diode. However, as disclosed by Watanabe, Misawa et al. in “Three-Dimensional Optical Data Storage in Vitreous Silica”, JJAP Vol. 37 (1998), pp. L1527 to L1530, if the storage layer is made of quartz, then a peak laser output as high as 1.33 Mw is needed in 120 femtoseconds to carry out a write operation. Only a titanium-sapphire laser can have that high optical output.

As can be seen from the foregoing description, it seems to be virtually impossible to realize a multiphoton absorption storage operation in consumer electronic appliances by using a conventional material. That is to say, the present inventors discovered that to realize the multiphoton absorption storage in actual products by increasing the sensitivity of the storage layer, the storage layer should include a material with a lower thermal conductivity, a lower thermal deformation temperature and a larger third-order nonlinear constant. The reasons are as follows. Specifically, if the material of the storage layer has a low thermal conductivity, then the temperature of the storage layer can be increased locally at a higher rate. Also, if the material of the storage layer has a low thermal deformation temperature, then the storage layer will be deformed easily under the heat generated by the multiphoton absorption. Furthermore, if the material of the storage layer has a large third-order nonlinear constant, then heat will be generated more efficiently as a result of the multiphoton absorption.

Thus, in view of these considerations, the present inventors carried out researches into (A) materials for the storage layer and (B) structures of the optical information storage medium. As used herein, the “optical information storage medium” may broadly refer to any medium from/on which information is read or written by way of light, and is typically an optical disk.

First, the present inventors researched into (A) materials for the storage layer. Specifically, we paid special attention to organic materials as materials with low thermal conductivities and analyzed the properties of various organic materials that would produce the multiphoton absorption. In those researches, the storage layer made of an organic material was supposed to be substantially transparent to the read beam and the write beam. This condition was set to store information in multiple storage layers. As used herein, “to store information in multiple layers” (or to carry out “multilayer storage”) means to make information signal tracks between the substrate and the surface of a given optical information storage medium. For example, the information signal tracks may be left in multiple stages within a single storage layer. Alternatively, a single track of information signals may be left in each of multiple storage layers stacked.

In this case, the write beam (i.e., light beam for writing) had a wavelength λ_{w} of 800 nm, while the read beam (i.e., light beam for reading) has a wavelength λᵣ of 400 nm. A light beam with any of these wavelengths can be emitted by a conventional semiconductor laser diode. Hereinafter, it will be described why the wavelength of the read beam was set shorter than that of the write beam.

Supposing the wavelength of the write beam is represented by λ_{w} (μm) and the numerical aperture of an objective lens for writing is represented by NA, the size of pits (which will be referred to herein as a “pit diameter”) to make in a conventional storage layer that produces single photon absorption is given by λ_{w}/NA (μm). On the other hand, in the storage layer that produces multiphoton absorption, the diameter of resultant pits is given by λ_{w}²/NA (μm), which is smaller than the conventional pit diameter (=λ_{w}/NA). Accordingly, to read information from the pits that have been created in the storage layer with the write beam having the wavelength λ_{w}, a light beam having a wavelength λᵣ, which is shorter than the wavelength λ_{w} of the write beam, needs to be used.

The present inventors tested various organic materials.

As a result, we discovered that the recording sensitivity could be increased more effectively by using either polydiacetylene or merocyanine. Each of these materials has (a) a relatively low thermal conductivity, (b) a low thermal deformation temperature, and (c) a large third-order nonlinear constant.

Next, the present inventors also researched into (B) the structures of the optical information storage medium.

More specifically, the present inventors considered how to modify the structure of the optical information storage medium when pits should be made in a storage layer, of which the material does not satisfy all of these three requirements (a), (b) and (c). For example, inorganic compounds such as tellurium oxides (typically tellurium dioxide), zinc oxides, and zinc sulfides have high thermal conductivities and low thermal deformability (i.e., fail to satisfy the requirements (a) and (b)). Thus, it would be difficult to obtain a storage layer with high recording/reproducing sensitivity just by using any of these inorganic compounds. However, these inorganic compounds have a large third-order nonlinear constant. For that reason, if one of these inorganic compounds is used, storage might be realized with higher sensitivity. Furthermore, if the storage layer made of one of these inorganic compounds is amorphous, then the storage layer is transparent to the wavelength of the write laser beam and therefore, the storage density can be increased by performing the multilayer storage.

As a result of these researches, the present inventors discovered that by providing a thermoplastic resin layer in contact with the surface of the storage layer, pits could be made easily due to thermal deformation and the recording/reproducing sensitivity could be improved.

Hereinafter, preferred embodiments of an optical information storage medium according to the present invention will be described more specifically with reference to the accompanying drawings.

### Embodiment 1

An optical information storage medium according to a first preferred embodiment of the present invention has the same configuration as the conventional optical disk shown in FIG. 8. The difference lies in the material of the storage layer 57.

As shown in FIG. 8, the optical information storage medium of this preferred embodiment includes a substrate 56 and a storage layer 57 provided on the substrate 56. The substrate 56 may be made of polycarbonate, for example. The storage layer 57 may be made of a material including merocyanine (with a thermal conductivity of 0.08 W/m·K to 0.2 W/m·K), i.e., a merocyanine compound. Also, the storage layer 57 is amorphous, and therefore, is transparent with respect to both the read beam and the write beam described above. The storage layer 57 may have a thickness of 50 μm, for example. The surface of the storage layer 57 is preferably covered with a protective coating 50 that protects the storage layer 57.

In writing information on the optical information storage medium, a write beam (with a wavelength of 800 nm) 2, emitted from a light source, for example, is focused through an objective lens 1 onto the storage layer 57. A portion of the storage layer 57 in which the focal point 3 has been formed (i.e., the portion surrounding the focal point 3) produces multiphoton absorption, generates heat and is deformed locally due to the heat. As a result, pits are made in the vicinity of the focal point 3.

On the other hand, in reading the information from the optical information storage medium, on which the information has been written in this manner, a read beam (with a wavelength of 400 nm) 2, emitted from a light source, for example, is focused through the objective lens 1 onto the storage layer 57 and then the light beam reflected is detected. In this manner, the information can be read out from the pits of the storage layer 57.

The optical information storage medium, having such a configuration, exhibits high recording sensitivity for the following reasons.

Firstly, merocyanine included in the storage layer 57 has a lower thermal conductivity of 0.08 W/m·K to 0.2 W/m·K than a conventional storage material (e.g., silica glass with a thermal conductivity of 1 W/m·K to 2 W/m·K). For that reason, the heat generated in the vicinity of the focal point 3 is not conducted to the surrounding portions so easily, and therefore, the heat can be used more efficiently. Secondly, the merocyanine compound has a relatively low thermal deformation temperature, and easily makes pits under the heat generated by the multiphoton absorption. Thirdly, merocyanine has a large third-order nonlinear constant of 81×10⁻¹² esu. Thus, this material generates heat highly efficiently as a result of the multiphoton absorption.

In addition, since the merocyanine compound has extremely low thermal conductivity as described above, tracks of information signals 55 can be left in multiple stages within the single storage layer 57 as shown in FIG. 8. That is to say, information can be stored there at a high density. Also, the optical information storage medium with such a structure has very high productivity.

Furthermore, the storage layer 57 is transparent to both the write beam and the read beam alike and is amorphous, too. Accordingly, even if the read and write beams used have mutually different wavelengths, no attenuation problem should arise.

The thickness of the storage layer 57 is not limited to the value specified above. In any case, the thickness is preferably defined so as not to reflect the write beam (with λ_{W} of 800 nm) but to reflect the read beam (with λᵣ of 400 nm). Then, with respect to the write beam, there is no reflected light and the maximum write efficiency is achieved. Meanwhile, the read beam is reflected and a read signal of quality can be obtained. More preferably, the thickness of the storage layer 57 is defined so as to reflect the read beam at the maximum rate.

The wavelengths of the write and reflected beams are not limited to the above values, either. However, the wavelength of the read beam is preferably about half of the wavelength of the write beam. Then, the thickness of the storage layer 57 can be defined advantageously so as not to reflect the write beam but to reflect the read beam at the maximum rate. For example, the write beam may have a wavelength λ_{w} of 405 nm and the read beam may have a wavelength λᵣ of 810 nm.

To evaluate the recording sensitivity of this optical information storage medium, a sample disk 1 may be made in the following manner.

First, merocyanine is dissolved in chloroform to obtain a merocyanine solution. Next, the merocyanine solution is applied onto the substrate 56 of polycarbonate. The volume of the merocyanine solution applied is adjusted such that the resultant merocyanine layer will have a thickness of 1 μm, for example. The merocyanine solution may be applied by any known coating technique such as a spin coating technique. In this manner, the sample disk 1, in which the merocyanine layer has been deposited on the substrate 56, is obtained.

It should be noted that chloroform may function as a solvent for carbonate. Thus, the polycarbonate substrate 56 might be damaged. If the substrate 56 could be damaged by the solvent seriously, then a protective coating should be provided on the surface of the substrate 56 before the merocyanine solution is applied thereto. The protective coating may be made of a UV curing resin, for example.

The spectral characteristic of the merocyanine layer was evaluated using this sample disk. The results are shown in FIG. 4. As can be seen from FIG. 4, this storage layer 57 exhibits low absorbance with respect to the light with a wavelength of 800 nm and to the light with a wavelength of 400 nm. In other words, the storage layer 57 exhibits good transmittance with respect to the light with any of these wavelengths. As can be seen from these results, it can be seen that when the write beam is focused on the lowermost storage layer 57 of this optical information storage medium 100, then the write beam will not be absorbed into any storage layer 57 located over the former storage layer 57. In addition, this layer is amorphous and never scatters the write beam.

If a laser beam with a wavelength of 800 nm, which has been emitted from a pulsed semiconductor laser diode with a peak output of 600 mW and an output pulse width of 5 nanoseconds, is focused on this sample disk 1 through an objective lens with an NA of 0.85, then good signal pits can be created in the merocyanine layer. Consequently, it can be seen that information can be written on the merocyanine layer using a conventional semiconductor laser diode since the merocyanine layer has high recording sensitivity.

It should be noted that the write beam emitted from a semiconductor laser diode, for example, preferably has one emission period length of 15 nanoseconds to 15 picoseconds because the maximum sensitivity is achieved in that case.

In the sample disk 1 described above, the storage layer has a thickness of 1 μm. However, if a storage layer of the same merocyanine compound is deposited to a thickness of about 50 μm, then information signal tracks 55 can be made in multiple stages in the single storage layer 57 by using the semiconductor laser diode described above.

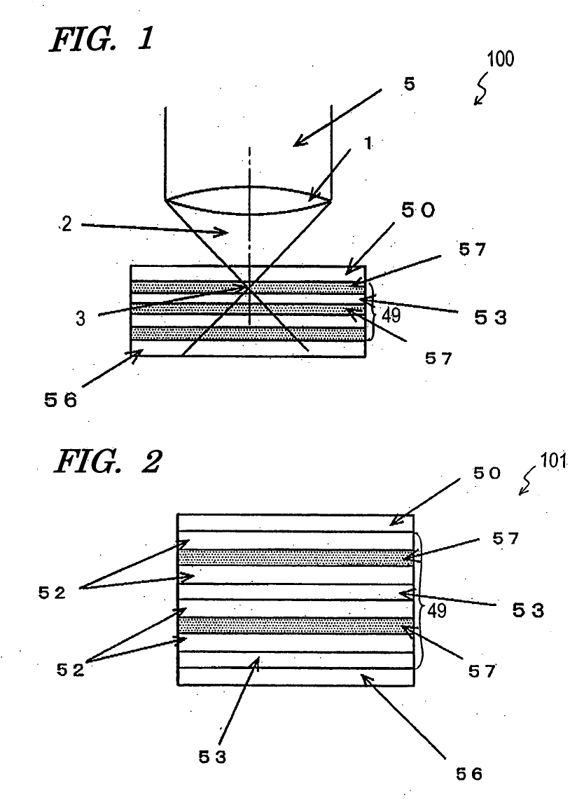

In the preferred embodiment described above, just one storage layer 57 is provided on the substrate 56 as shown in FIG. 8. Alternatively, a number of storage layers 57 may also be stacked one upon the other as shown in FIG. 1. In that case, information signal tracks 55 may be left either in a single stage for each of those storage layers 57 or in two or more stages for some of them. It should be noted that two adjacent storage layers 57 are preferably separated from each other by a separating layer 53 with low thermal conductivity. As the material of the separating layer 53, either a resin or an inorganic material, which would not be damaged by a solvent for the storage layer 57 to be deposited on the separating layer 53, is preferably selected. The separating layer 53 of a UV curable resin, for example, may be easily deposited by a known method.

In the preferred embodiment described above, an organic material is used as the storage material. However, according to the present invention, the storage material does not have to be an organic material. The present inventors tested various inorganic materials from the viewpoint of recording sensitivity. As a result, the present inventors discovered that a high-sensitivity storage layer could also be formed even when a compound obtained by adding lithium, sodium, tungsten and so on to a tellurium oxide (e.g., tellurium dioxide) was used as the multiphoton absorption storage material. A high-sensitivity storage layer can also be made of a zinc oxide, a zinc sulfide, etc.

### Embodiment 2

An optical information storage medium according to this preferred embodiment has the same configuration as the counterpart that has already been described for the first preferred embodiment with reference to FIG. 8. However, the former storage medium is different from the latter storage medium in that a material including polydiacetylene (with a thermal conductivity of 0.08 W/m·K to 0.2 W/m·K) is used as the material of the storage layer 57. Polydiacetylene has almost as small a thermal conductivity as, and is as easily thermally deformed as, merocyanine. That is why the storage layer 57 of this preferred embodiment exhibits almost as high recording sensitivity as the storage layer made of a merocyanine compound of the first preferred embodiment.

To evaluate the recording sensitivity of this preferred embodiment, a sample disk 2 is made in the following manner.

First, a polydiacetylene solution is obtained by dissolving a polydiacetylene monomer in ethyl acetate, and then applied onto a polycarbonate substrate by a spin coating technique. Next, with the substrate heated to 60° C., the polydiacetylene solution applied (with a thickness of 1 μm) is exposed to an ultraviolet ray for one hour so as to be cured with the UV ray. In this manner, a polydiacetylene layer is formed on the substrate (as a sample disk 2a). Polydiacetylene has three phases of red, blue and colorless phases. The polydiacetylene layer obtained by this method has blue phase.

Subsequently, Sample Disks Nos. 2b and 2c are made. As the polydiacetylene solution is being cured with the UV ray in an increasing amount of time, the resultant polydiacetylene layer goes through the red phase, blue phase and then colorless phase. Thus, after the polydiacetylene solution has been applied as described above, the solution is cured with the UV ray in less than one hour, thereby obtaining a sample disk 2c made of red-phase polydiacetylene. In the same way, the solution is cured with the UV ray in more than one hour, thereby obtaining a sample disk 2c made of colorless-phase polydiacetylene.

The spectral characteristic of the sample disk 2a was evaluated. The results are shown in FIG. 5. As can be seen from FIG. 5, the storage layer 57 of polydiacetylene exhibits very good transmittance with respect to the light with a wavelength of 800 nm and to the light with a wavelength of 400 nm. In addition, this layer is amorphous and never scatters the light with any of these wavelengths.

If a laser beam with a wavelength of 800 nm, which has been emitted from a pulsed semiconductor laser diode with a peak output of 600 mW and an output pulse width of 5 nanoseconds, is focused on the sample disk 2a through an objective lens with an NA of 0.85, then good signal pits can be created in the sample disk 2a. Consequently, it can be seen that information can be written on the sample disk 2a using a conventional semiconductor laser diode since the sample disk 2a has high sensitivity.

Evaluating the spectral characteristics of the sample disks 2b and 2c, it can be seen that the sample disk 2b (in red phase) is transparent to light with a wavelength of 800 nm and light with a wavelength of 400 nm, while the sample disk 2c (in colorless phase) is completely transparent to the light falling within almost all of the wavelength range of 900 nm through 400 nm.

If a laser beam with a wavelength of 800 nm, which has been emitted from a pulsed semiconductor laser diode with a peak output of 800 mw and a pulse width of 5 nanoseconds, is focused on the sample disk 2c through an objective lens with an NA of 0.85, then good signal pits can be created in the sample disk 2c. In the prior art, the colorless-phase polydiacetylene film was regarded as a deteriorated film in which chemical bonds are broken by an ultraviolet ray. However, it can be seen that multiphoton absorption storage with rather high sensitivity is realized by using a storage layer made of such a colorless-phase polydiacetylene.

As in the first preferred embodiment described above, the optical information storage medium of this preferred embodiment may also have a plurality of storage layers 57 as shown in FIG. 1.

### Embodiment 3

FIG. 1 is a schematic representation showing the configuration of an optical information storage medium 100 according to this preferred embodiment.

The optical information storage medium 100 includes a substrate 56 and a multilayer structure 49 provided on the substrate 56. The substrate 56 may be made of polycarbonate, for example. The multilayer structure 49 includes a storage layer 57 (with a thickness of 0.25 μm, for example). The storage layer 57 may be made of a material including either merocyanine (with a thermal conductivity of 0.08 W/m·K to 0.2 W/m·K) or polydiacetylene (with a thermal conductivity of 0.08 W/m·K to 0.2 W/m·K). Also, the storage layer 57 is amorphous, and therefore, is transparent with respect to both the read beam and the write beam described above. In this preferred embodiment, ten storage layers 57 are provided (only three of which are illustrated in FIG. 1 for the sake of simplicity). It should be noted that the number of storage layers 57 to provide is not particularly limited as long as at least one storage layer 57 is present. To increase the storage density, however, the number of storage layers 57 may be five or more. The reason is that the light attenuation problem described above never happens since the storage layers 57 are transparent to the read/write beams. The number of storage layers 57 to provide is more preferably 10 or more. In any case, where a plurality of storage layers 57 are provided in this manner, two adjacent storage layers 57 are preferably separated from each other by a separating layer (with a thickness of about 10 μm, for example) 53 made of a 15 UV curable resin, for example. The top of the multilayer structure 49 is preferably covered with a protective coating 50 that protects the storage layers 57. The protective coating 50 may be a polycarbonate sheet (with a thickness of about 100 μm, for example).

In writing information on the optical information storage medium 100, a write beam (with a wavelength of 800 nm) 5, emitted from a light source, for example, is focused through an objective lens 1 onto a target one of the storage layers 57. A portion of the storage layer 57 in which the focal point 3 has been formed (i.e., the portion surrounding the focal point 3) produces multiphoton absorption, generates heat, and is deformed locally due to the heat. As a result, pits are made in the vicinity of the focal point 3. Multilayer storage is realized by sequentially focusing the write beam on, and writing information on, one of the storage layers 57 after another.

On the other hand, in reading the information from the optical information storage medium 100, on which the information has been written in this manner, a parallel light beam 5 as a read beam (with a wavelength of 400 nm), emitted from a light source, for example, is focused through the objective lens 1 onto the target storage layer 57 and then the light beam reflected is detected. In this manner, the information can be read out from the pits of that storage layer 57.

In this optical information storage medium 100, the storage layers 57 are made of a material including either merocyanine or polydiacetylene. Thus, as already described for the first preferred embodiment, the optical information storage medium 100 can exhibit improved recording sensitivity.

Also, the optical information storage medium 100 has a structure in which relatively thin storage layers 57 are stacked one upon the other as shown in FIG. 1. Accordingly, the storage layers 57 can be made easily. A structure like this is particularly effective if it is difficult to make a thick storage layer 57 such as that shown in FIG. 8 out of the material including merocyanine or polydiacetylene.

A sample multilayer disk 3 of the optical information storage medium 100 can be made in the following manner.

First, a merocyanine solution is applied onto the substrate (such as a polycarbonate resin substrate) 56 by the same method as that already described for the first preferred embodiment, thereby depositing a storage layer (with a thickness of 0.25 μm, for example) 57 of a merocyanine compound. Next, a solution including a UV curable resin is applied to a thickness of about 10 μm and then irradiated and with an ultraviolet ray, thereby curing the UV curable resin and forming a separating layer 53 (with a thermal conductivity of 0.08 W/m·K to 0.3 W/m·K). Thereafter, another storage layer (with a thickness of 0.25 μm) 57 of the merocyanine compound is deposited thereon. By repeatedly performing these process steps, 10 storage layers 57 or so are formed. After the uppermost storage layer 57 is complete, a polycarbonate sheet with a thickness of about 100 μm is attached thereto, thereby providing a protective coating 50. In this manner, a sample multilayer disk 3 can be obtained.

When a parallel light beam 5 with a wavelength λw of 800 nm, emitted from a semiconductor laser diode, is focused on one of the storage layers 57 included in this sample multilayer disk 3 through an objective lens 1 with an NA of 0.85, multiphoton absorption is produced and heat is generated in the vicinity of the focal point 3 in that storage layer 57. Pits are created under this heat in the vicinity of the focal point 3 in the storage layer 57. The shape of those pits changes with the storage material adopted or the intensity of the write beam but is typically either a thermally strained portion or an opening. In this case, the thickness (of 0.25 μm) of the storage layer 57 is about half of the wavelength λw of the write beam. For that reason, the light reflected from the upper surface of the storage layer 57 and the light reflected from the lower surface thereof cancel each other, and almost no sensible light is reflected from the storage layer 57 as for the write beam.

Next, a parallel light beam 5 with a wavelength λr of 400 nm, emitted from a semiconductor laser diode, is focused on the storage layer 57 with the pits, and then the reflected light is detected. In this case, the thickness of the storage layer 57 is approximately equal to the wavelength λr of the read beam. Thus, the light reflected from the upper surface of the storage layer 57 and the light reflected from the lower surface thereof enhance each other, thereby producing maximum reflected light. As a result, the variation of the light that has been reflected from the portions of the storage layer 57 with the pits (i.e., thermally strained portions or openings) is maximized. Then, the maximum signal modulation rate is achieved.

In the preferred embodiment described above, either merocyanine or polydiacetylene is used as the storage material. However, the storage materials of the present invention are not limited to such organic materials. For example, the storage layer 57 may also be made of an inorganic material (such as tellurium oxide (e.g., tellurium dioxide), zinc oxide or zinc sulfide) as mentioned for the first preferred embodiment.

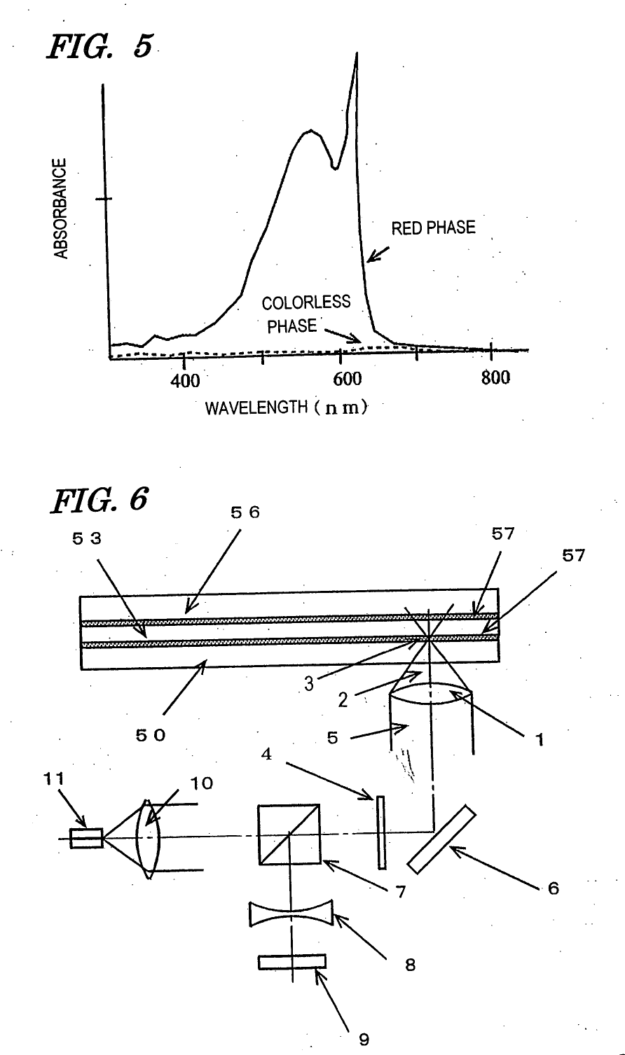

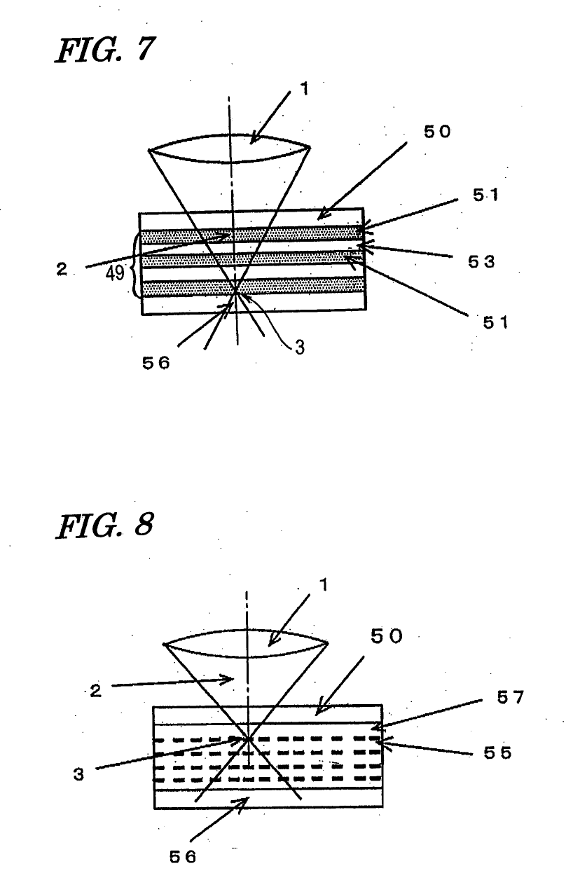

To read and/or write information from/on the optical information storage medium 100, a read/write drive such as that shown in FIG. 6 may be used, for example.

The read/write drive shown in FIG. 6 includes a semiconductor laser diode 11 that emits a linearly polarized light beam, a collimator lens 10 that collimates the output light beam of the semiconductor laser diode 11 into a parallel light beam, a polarization beam splitter 7 that splits the light beam, which has come from the collimator lens 10, into two light rays, a focus detecting lens 8, a signal detecting photodetector 9, a λ/4 (quarter wave) plate 4, a refracting mirror 6 and an objective lens 1. One of the two light rays produced by the splitting by the polarization beam splitter 7 is transmitted through the focus detecting lens and then incident onto the signal detecting photodetector 9. The other light ray is transmitted through the polarization beam splitter 7 as it is, passed through the λ/4 plate 4, has its optical path changed by the refracting mirror 6, and then is focused through the objective lens 1 onto the storage layer 57 of the optical information storage medium 100. If the light beam emitted from the semiconductor laser diode 11 is a write beam (with a wavelength of 800 nm, for example), then thermal deformation is produced at the focal point 3 in the storage layer 57 to create pits there. On the other hand, if the light beam emitted from the semiconductor laser diode 11 is a read beam (with a wavelength of 400 nm, for example), then the read beam is reflected by the storage layer 57. The reflected beam is passed through the objective lens 1 and the refracting mirror 6 and then returned to the polarization beam splitter 7. Thereafter, the reflected light has its optical path changed by the polarization beam splitter 7, is converged by the focus detecting lens 8 onto the signal detecting photodetector 9 and then is detected by the signal detecting photodetector 9.

### Embodiment 4

The configuration of this preferred embodiment is different from that shown in FIG. 1 in that a thermoplastic resin layer with a low thermal deformation temperature is provided in contact with each of multiple storage layers 57. By inserting those thermoplastic resin layers, pits can be created more easily in the storage layers 57 through the thermal deformation. Accordingly, even if the storage layers 57 are made of an inorganic compound that has high thermal conductivity and is not thermally deformed easily, high recording/reproducing sensitivity is still achieved. Hereinafter, a specific configuration for the optical information storage medium of this preferred embodiment will be described.

The optical information storage medium 101 shown in FIG. 2 includes a substrate 56 and a multilayer structure 49 provided on the substrate. The multilayer structure 49 includes a plurality of storage layers 57 and separating layers 53 for separating two adjacent storage layers 57 from each other. Each of the storage layers 57 is sandwiched between two thermoplastic resin layers 52. Alternatively, the thermoplastic resin layer 52 may also be arranged so as to surround the respective storage layers 57. The storage layers 57 are amorphous layers made of a tellurium oxide compound, for example. The material of the storage layers 57 is not particularly limited. But the storage layers 57 are preferably substantially transparent. The thermoplastic resin layers 52 may be made of any resin with thermoplasticity and a low thermal deformation temperature and are preferably made of styrene, polystyrene, polyurethane or any other resin. The thermoplastic resin layers 52 may have a thermal conductivity of 0.08 W/m·K to 0.3 W/m·K. In FIG. 2, only two storage layers 57 are illustrated for the sake of simplicity. However, the present invention is in no way limited to this specific preferred embodiment. The multilayer structure 49 just needs to include at least one storage layer 57 but preferably includes two or more storage layers 57 to increase the storage density. Information can be read or written from/on each of the storage layers 57 of the optical information storage medium 101 by the same method as that already described with 10 reference to FIG. 1.

As the material of the storage layers 57, an inorganic oxide or an inorganic sulfide may be used, for example. Examples of preferred inorganic oxides and inorganic sulfides include tellurium oxides, zinc oxides, and zinc sulfides. These inorganic materials are advantageous because their third-order nonlinear constant is relatively large. Also, when any of these inorganic materials is used, the storage layers 57 are preferably amorphous layers of the inorganic material. Since those amorphous layers are translucent, light is not absorbed thereto easily except the multiphoton absorption. Thus, information can be stored there just as intended. Furthermore, in performing multilayer storage, the number of layers can be increased and therefore high storage density is achieved. For example, if a tellurium oxide is used as the inorganic oxide, the tellurium oxide alone cannot be vitrified (i.e., amorphized) easily. However, if 10 wt % or more of sodium (Na), phosphorus (P), lithium (Li) and so on is added to the tellurium oxide, then the vitrification range of the tellurium oxide can be expanded and an amorphous layer can be produced easily. The vitrification range when the tellurium oxide includes various additives is described in detail by Raouf, A. H. and El Mallawany in “Tellurite Glasses Handbook”, pp. 20-22.

In this optical information storage medium 101, each storage layer 57 is sandwiched between (or surrounded with) the thermoplastic resin layer(s) 52. Accordingly, the heat generated in the portion of the storage layer 57 where multiphoton absorption has been produced (i.e., portion in the vicinity of the focal point 3) deforms not only the storage layer 57 itself but also the thermoplastic resin layers 52 sandwiching or surrounding that storage layer 57. As a result, the heat generated by the multiphoton absorption creates pits even more accurately and therefore further increases the recording sensitivity. Particularly when an inorganic material (such as a tellurium oxide, a zinc oxide or a zinc sulfide) is used as the storage material, the storage layer 57 has good thermal conductivity. Accordingly, by inserting the thermoplastic resin layers 52, the recording sensitivity can be increased significantly.

Each thermoplastic resin layer 52 is preferably in contact with its associated storage layer 57. Then, the heat generated in the storage layer 57 can be conducted to the thermoplastic resin layer 52 efficiently and the recording sensitivity can be improved even more effectively.

The optical information storage medium 101 may be made in the following manner, for example.

First, a separating layer (with a thickness of 5 μm to 10 μm, for example, and a thermal conductivity of 0.08 W/m·K to 0.3 W/m·K) 53 is deposited on a polycarbonate substrate 56. The separating layer 53 may be made of a UV curable resin, for example, and may be formed by a spin coating technique or any other known coating method.

Next, a thermoplastic resin layer 52 of polystyrene (with a thickness of 0.5 μm to 5 μm, for example) is deposited by a spin coating technique, for example. Subsequently, a storage layer 57 (with a thickness of 0.05 μm to 1 μm) is deposited on the thermoplastic resin layer 52 by a spinner method or an evaporation process. In this preferred embodiment, a tellurium oxide compound, obtained by adding lithium or Na as an additive to a tellurium oxide, is used as the material of the storage layer 57. The method of adding the additive to the tellurium oxide is not particularly limited. For example, after the tellurium oxide has been added to, and mixed with, sodium carbonate, the mixture may be melted. As a result, the carbonic acid included in the sodium carbonate is vaporized and scattered into the air, and only Na can be added to the tellurium oxide. The total amount of the additives is preferably 10 wt % to 30 wt %.

Thereafter, another thermoplastic resin layer 52 is deposited thereon by the same method. Next, another separating layer 53 is formed thereon by the same method as that described above, and then still another thermoplastic resin layer 52, another storage layer 57 and yet another thermoplastic resin layer 52 are deposited in this order.

Subsequently, a polycarbonate sheet with a thickness of about 100 μm is attached so as to cover the uppermost thermoplastic resin layer 52, thereby providing a protective coating 50. In this manner, an optical information storage medium 101 can be obtained.

Next, to evaluate the recording sensitivity of the storage layer 57 itself, a sample disk 4, in which a tellurium oxide layer (with a thickness of 0.25 μm) including lithium as an additive was provided on a polycarbonate substrate, was made. For the purpose of comparison, a comparative disk, in which a silica glass layer (with a thickness of 2.5 μm) was provided on a polycarbonate substrate, was also made. In this preferred embodiment, “the recording sensitivity (which will be sometimes referred to herein as just “sensitivity”)” is evaluated by the intensity of light to be focused on a storage layer when a pit with a predetermined shape needs to be created in the storage layer. That is to say, the lower the intensity of the light that should be focused to create a pit in a predetermined shape, the higher the recording sensitivity. Specifically, the recording sensitivities of the respective storage layers of these two sample disks may be compared with each other in the following manner.

When a laser beam (i.e., write beam) is focused on each of those storage layers through an objective lens (with an NA of 0.85), pits are created in that storage layer. In this case, if the intensity of the laser beam is changed, then the size of the pits to be created (pit diameter) will also change. Thus, by measuring the intensity I of the laser beam that creates pits of a predetermined pit diameter (of 0.1 μm to 1 μm) in each of these storage layers and by comparing the intensities I with each other, the recording sensitivities can also be compared. In this preferred embodiment, a light beam with a wavelength of 533 nm was focused on each of the storage layers by using a pulsed YAG laser with a pulse width of 5 nsec and a repetitive frequency of 10 Hz.

As a result, the tellurium oxide layer of the sample disk 4 needed light with an intensity of 10 nJ, while the silica glass layer of the comparative disk needed light with an intensity of 200 nJ. Thus, the present inventors confirmed that the recording sensitivity of the storage layer of tellurium oxide was higher than that of the conventional storage layer by at least one order of magnitude.

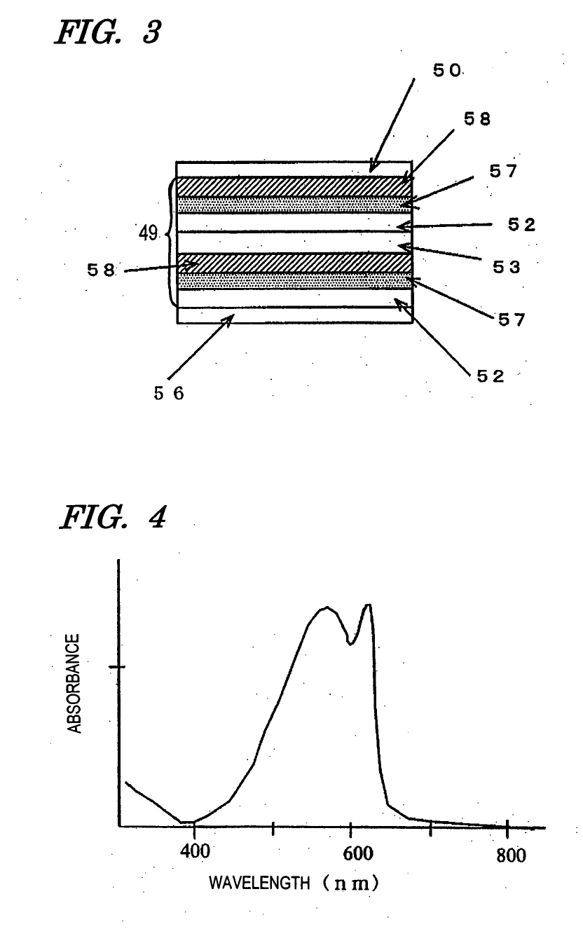

In the optical information storage medium 101, each storage layer (with a thickness of 0.05 μm to 1 μm) 57 is sandwiched between two thermoplastic resin layers 52. However, the configuration of the optical information storage medium of the present invention is in no way limited to this specific preferred embodiment. Alternatively, the thermoplastic resin layer (with a thickness of 2 μm, for example) 52 may be provided only on the upper surface or the lower surface of each storage layer 57 as shown in FIG. 3. Then, the heat generated in the storage layer 57 and thermal stress are transmitted only in the single direction (i.e., either upward or downward from the storage layer 57). In that case, a heat insulating layer (or heat shutoff layer) 58 of a titanium oxide, for example, may be provided on the other side of the storage layer 57. As the material of the heat insulating layer 58, either an inorganic material with high thermal deformation temperature and high hardness (i.e., low deformability) such as a titanium oxide or an organic material such as a thermosetting resin with high hardness or a UV curable resin may be used, for example. The heat insulating layer 58 may have a thermal conductivity of 0.08 W/m·K to 0.3 W/m·K and a thickness of about 0.5 μm to about 3 μm, for example. If the heat insulating layer 58 is provided in contact with one side of its associated storage layer 57, then neither the heat generated in the storage layer 57 nor thermal strain will be propagated to the heat insulating layer 58. By controlling the transfer of the heat generated in the storage layer 57 in this manner, pits can be created in any desired shape with the temperature of the storage layer 57 raised at a sufficiently high rate constantly where those pits should be formed.

Each separating layer 53 for use in the optical information storage medium shown in FIG. 3 is backed with the heat insulating layer 58. Accordingly, a hard UV curable resin, which is not easily deformable thermally, for example, is preferably used as the material of the separating layer 53. The separating layer 53 may have a thickness of about 5 μm to about 10 μm.

The thermoplastic resin layers 52 may be provided either on both sides of each storage layer 57 as shown in FIG. 2 or on just one side thereof as shown in FIG. 3. A preferred material for the thermoplastic resin layer 52 that contacts with the storage layer 57 is styrene, polystyrene, polyurethane or any other resin that easily deforms under the heat. When the storage layer 57 generates heat, the thermoplastic resin layer 52 easily deforms locally. As a result, a signal can be written as the film deformation.

This configuration with the thermoplastic resin layers 52 is effectively applicable to an optical information storage medium including storage layers with a high thermal deformation temperature. Examples of such storage layers include not just the storage layers made of the inorganic compound described above but also storage layers made of a known inorganic or organic material or merocyanine or any other material used in some other preferred embodiment of the present invention. However, significant effects are achieved particularly when the configuration described above is applied to an optical information storage medium including storage layers of an inorganic material.

When the thermoplastic resin layer 52 and the heat insulating layer 58 are arranged appropriately on the surfaces of each storage layer 57 as shown in FIG. 2 or 3, pits can be created more easily under the heat generated in the storage layer 57 and yet the diffusion of the heat generated in the storage layer 57 can be controlled. That is to say, the properties of the storage layer 57 can be corrected appropriately. As a result, the material of the storage layer 57 can be selected from a broader variety. For example, to increase the recording sensitivity, a material with a large third-order nonlinear constant (of at least 0.5×10⁻¹² esu preferably) may be freely selected as the material of the storage layer 57. Examples of preferred materials for the storage layer 57 include a tellurium oxide (e.g., tellurium dioxide) with a third-order nonlinear constant of 1.3×10⁻¹² esu and a zinc oxide with a third-order nonlinear constant of 0.8×10⁻¹² esu. Any of these oxide compounds may include an appropriate amount of additives such as lithium (Li) and sodium (Na). Specifically, a compound obtained by adding 25 lithium to 75 TeO₂ (i.e., a compound consisting of 75 mol % of tellurium dioxide and 25 mol % of lithium, which will be sometimes referred to herein as “lithium-added tellurium oxide”) may be used, for example. The third-order nonlinear constant of this compound of 1.4×10⁻¹² esu is about twice as large as that of a compound obtained by adding 15 mol % of sodium oxide to TeO₂ (which will be sometimes referred to herein as “Na-added tellurium dioxide”).

The Li-added tellurium oxide has higher hardness than the Na-added tellurium oxide. Accordingly, in the configuration including no thermoplastic resin layers 52 (such as that shown in FIG. 1), the recording sensitivity of the Li-added tellurium oxide storage layer is lower than that of the Na-added tellurium oxide storage layer. On the other hand, if the soft thermoplastic resin layer 52 is provided on at least one side of the Li-added tellurium oxide storage layer, then the recording sensitivity of an optical information storage medium including the Li-added tellurium oxide storage layer can be about twice higher than that of an optical information storage medium including the Na-added tellurium oxide storage layer. It should be noted that the thermoplastic resin layer 52 also has the function of compensating for the hardness of the Li-added tellurium oxide storage layer and its poor contact with other layers.

According to the present invention, a material with low thermal deformation temperature, low thermal conductivity and high heat generating efficiency (i.e., a large third-order nonlinear constant) is used as the material of the storage layer. Thus, physical spots can be created in the storage layer by utilizing multiphoton absorption, and the recording/reproducing sensitivity can be increased as a result. In addition, by performing a multilayer storage operation, the storage density can be increased.

Furthermore, according to the present invention, at least one thermoplastic resin layer is provided on the upper surface and/or lower surface of the storage layer, and therefore, physical spots can be easily created in the storage layer by utilizing the multiphoton absorption. Consequently, the material of the storage layer can be selected from a broader variety. It is particularly advantageous to choose a material with a large third-order nonlinear constant as the material of the storage layer.

### INDUSTRIAL APPLICABILITY

According to the present invention, physical pits can be created in the storage layer by utilizing multiphoton absorption, and therefore, an optical information storage medium with high recording/reproducing sensitivity can be provided. In addition, a method and apparatus for reading and writing information from/on such an optical information storage medium is also provided. It is advantageous to perform a multilayer storage operation on this optical information storage medium because the storage density can be increased in that case.

1. An optical information storage medium comprising
a substrate, and
a multilayer structure, which is provided on the substrate and includes at least one storage layer,
wherein the at least one storage layer includes polydiacetylene or merocyanine and is amorphous.

2. The optical information storage medium of claim 1, wherein the multilayer structure further includes a thermoplastic resin layer that is arranged so as to contact with at least one surface of the at least one storage layer.

3. An optical information storage medium comprising
a substrate, and
a multilayer structure, which is provided on the substrate and includes at least one storage layer,
wherein the multilayer structure further includes a thermoplastic resin layer that is arranged so as to contact with at least one surface of the at least one storage layer.

4. The optical information storage medium of claim 3, wherein the at least one storage layer includes at least one compound selected from the group consisting of tellurium oxide, zinc oxide and zinc sulfide and is amorphous.

5. The optical information storage medium of claim 3, further comprising a heat insulating layer for reducing conduction of heat that has been generated in the at least one storage layer,
wherein the thermoplastic resin layer is arranged so as to contact with one surface of the at least one storage layer, and the heat insulating layer is arranged so as to contact with the other surface of the at least one storage layer.

6. The optical information storage medium of claim 5, wherein the heat insulating layer includes either a thermosetting resin or an inorganic oxide or inorganic sulfide that is different from the material of the at least one storage layer.

7. The optical information storage medium of claim 1, wherein the at least one storage layer is substantially transparent to a write beam with a first wavelength and a read beam with a second wavelength, and produces multiphoton absorption against the write beam.

8. The optical information storage medium of claim 7, wherein the material of the at least one storage layer has a third-order nonlinear constant of at least 0.5×10⁻¹² esu.

9. The optical information storage medium of claim 7, wherein the second wavelength is approximately half as long as the first wavelength.

10. The optical information storage medium of claim 7, wherein the thickness of the at least one storage layer is defined so as not to reflect the write beam but to reflect the read beam.

11. The optical information storage medium of claim 1, comprising a plurality of storage layers, including the at least one storage layer, wherein the storage layers are arranged so as to be spaced apart from each other by a separating layer.

12. The optical information storage medium of claim 1, wherein information is stored in multiple layers within the at least one storage layer.

13. A method for reading and/or writing information from/on the optical information storage medium of claim 1, the method comprising the step(s) of
writing the information including the step of producing multiphoton absorption locally in the at least one storage layer of the optical information storage medium by focusing a write beam having a first wavelength on the at least one storage layer, and/or
reading the information by focusing a read beam having a second wavelength on the at least one storage layer of the optical information storage medium and detecting light reflected therefrom.

14. An apparatus for reading and/or writing information from/on the optical information storage medium of claim 1, the apparatus performing the step(s) of
writing the information including the step of producing multiphoton absorption locally in the at least one storage layer of the optical information storage medium by focusing a write beam having a first wavelength on the at least one storage layer, and/or
reading the information by focusing a read beam having a second wavelength on the at least one storage layer of the optical information storage medium and detecting light reflected therefrom.

15. The apparatus of claim 14, wherein the second wavelength is approximately half as long as the first wavelength.

16. The apparatus of claim 14, wherein the write beam has one emission duration of 15 picoseconds to 15 nanoseconds.

17. The optical information storage medium of claim 3, wherein the at least one storage layer is substantially transparent to a write beam with a first wavelength and a read beam with a second wavelength, and produces multiphoton absorption against the write beam.

18. The optical information storage medium of claim 3, comprising a plurality of storage layers, including the at least one storage layer, wherein the storage layers are arranged so as to be spaced apart from each other by a separating layer.

19. The optical information storage medium of claim 3, wherein information is stored in multiple layers within the at least one storage layer.

20. A method for reading and/or writing information from/on the optical information storage medium of claim 3, the method comprising the step(s) of
writing the information including the step of producing multiphoton absorption locally in the at least one storage layer of the optical information storage medium by focusing a write beam having a first wavelength on the at least one storage layer, and/or
reading the information by focusing a read beam having a second wavelength on the at least one storage layer of the optical information storage medium and detecting light reflected therefrom.

21. An apparatus for reading and/or writing information from/on the optical information storage medium of claim 3, the apparatus performing the step(s) of
writing the information including the step of producing multiphoton absorption locally in the at least one storage layer of the optical information storage medium by focusing a write beam having a first wavelength on the at least one storage layer, and/or
reading the information by focusing a read beam having a second wavelength on the at least one storage layer of the optical information storage medium and detecting light reflected therefrom.
